(19) United States
(12) Patent Application Publication
(10) Pub. No.: US 2016/0080235 A1
(43) Pub. Date: Mar. 17, 2016

(54) SELECTIVE FORWARDING IN MOBILE CONTENT DELIVERY NETWORKS

(71) Applicant: QUALCOMM Incorporated, San Diego, CA (US)

(72) Inventors: Bo Tan, Bridgewater, NJ (US); Jubin Jose, Bound Brook, NJ (US); Xinzhou Wu, Hillsborough, NJ (US); Junyi Li, Chester, NJ (US); Sanjay Shakkottai, Austin, TX (US)

(21) Appl. No.: 14/485,234

(22) Filed: Sep. 12, 2014

(51) Int. Cl. H04L 12/26; H04W 8/08; H04L 29/08

(52) U.S. Cl. CPC H04L 43/0888; H04L 67/12; H04W 8/08

(57) ABSTRACT

Methods, systems, and devices are described for selecting data packets for forwarding in a vehicle network. In one example, a method includes receiving a first data packet at a first vehicle in a vehicular network and determining a geographic destination of the received first data packet. The method may also include forwarding the first data packet based at least in part on the geographic destination and a current wireless capacity of the vehicle network.

### BACKGROUND

The following relates generally to data transfers, and more specifically to leveraging both the physical mobility of vehicles and wireless communication networks to transfer data.

Wired communications systems, including particularly the Internet, are widely deployed to provide various types of high-speed and high-throughput data transfers between geographically separated locations. Although additional bandwidth is constantly being added to the Internet, the demand for transferring various types of data continues to surge. Moreover, even when additional bandwidth can be added, doing so is typically expensive due to the equipment, installation, and property costs involved in adding capacity.

The proliferation of mobile devices, such as smartphones and tablets which are enabled with data-intensive applications, has largely shifted user data traffic from traditional wireline networks to the mobile and wireless domain. Further, the cost of components in consumer products such as hard drives and wireless communication components, on the other hand, continues to decrease, notwithstanding the improvement in the durability and performance of these technologies. A mobile network may be composed of many types of devices as long as each device is equipped with data storage space and a wireless card which supports certain communication and networking standards.

### SUMMARY

The described features generally relate to one or more systems, methods, and/or apparatuses for data transfers over combined vehicular and wireless communication networks. A data packet may be wirelessly transmitted between a plurality of nodes and ultimately to a desired destination. At least one of the nodes may be a vehicle with physical mobility, which can physically transport a stored copy of the data packet, such as along one or more roads. The data packet may be wirelessly uploaded from a source node to a vehicle.

The vehicle travels some distance, carrying the data packet, after which the vehicle may wirelessly transmit the data packet to another vehicle (e.g., a target vehicle) based on a routing determination or resource allocation made by either the vehicle itself or by an external communications infrastructure. The determination of whether to wirelessly transmit the data packet may be based at least in part on a mobility pattern and a wireless capacity associated with the target vehicle to which the data packet may be transferred. That target vehicle may again wirelessly transmit the data packet to yet another vehicle, and so forth, until a vehicle is sufficiently close to the destination for wireless transmission of the data packet to the destination node, at which time that vehicle may wirelessly upload the data packet to a destination node.

In a first set of illustrative examples, a method for wireless communication is described. In one configuration, the method includes receiving a first data packet at a first vehicle in a vehicular network and determining a geographic destination of the received first data packet. The method also includes forwarding the first data packet based at least in part on the geographic destination and a current wireless capacity of the vehicular network.

In another example, the method also includes determining the current wireless capacity of the vehicular network within a transmission range of the first vehicle. In some examples, determining the current wireless capacity of the vehicular network within the transmission range of the first vehicle further includes determining a current wireless capacity of a second vehicle in the vehicular network, wherein the second vehicle is located within the transmission range of the first vehicle.

In yet another example, the method also includes determining a mobility pattern of at least a second vehicle located within a transmission range of the first vehicle, wherein forwarding the first data packet is further based at least in part on the determined mobility pattern. In some examples, the mobility pattern for the second vehicle comprises at least one of a direction of travel, a speed of travel, a route schedule, a destination of the second vehicle, or combinations thereof.

In additional examples, the method includes determining a first mobility pattern of a second vehicle located within a transmission range of the first vehicle. The method may also include determining a second mobility pattern of a third vehicle located within the transmission range of the first vehicle. The method further includes comparing the first mobility pattern to the second mobility pattern and selecting a vehicle from the second vehicle and the third vehicle based at least in part on the comparison of the first mobility pattern and the second mobility pattern. The method may also include forwarding the first data packet to the selected vehicle. In some examples of the method, selecting the vehicle further includes selecting the vehicle based at least in part on the second mobility pattern indicating that the second vehicle is expected to be closer to the geographic destination than the third vehicle and a wireless capacity of the second vehicle indicating that the second vehicle has available wireless capacity for the first data packet.

In another example of the method, receiving the first data packet further includes receiving a plurality of data packets. The method may also include determining a metric value for each of the plurality of data packets and selecting the first data packet from the plurality of data packets based at least in part on the first data packet having a highest metric value among the plurality of data packets. In some examples, the metric value is based at least in part on one or more of whether a geographic destination of the first data packet is within a first transmission range of the first vehicle, an expiration timer of the first data packet, whether the geographic destination is within a second transmission range of a second vehicle located within the first transmission range of the first vehicle, whether the geographic destination is within a third transmission range of a third vehicle located within the second transmission range of the second vehicle, and combinations thereof. The metric value may also be based at least in part on a type of the first vehicle. In further examples, the metric value is based at least in part on a ratio of a first distance between a current location of the first vehicle and the geographic destination and a second distance between a location of a source of the first data packet and the geographic destination.

In a second set of illustrative examples, an apparatus for transferring data is described. In one configuration, the apparatus may include means for receiving a first data packet at a first vehicle in a vehicular network and means for determining a geographic destination of the received first data packet. The apparatus may also include means for determining whether to wirelessly transmit the first data packet from a source to a target vehicle based at least in part on a physical mobility associated with the target vehicle.

In a third set of illustrative examples, another apparatus for transferring data is described. In one configuration, the apparatus may include a processor and a memory in electronic communication with the processor. The apparatus may further include instructions stored in the memory. The instructions stored in the memory may be executable by the processor to receive a first data packet at a first vehicle in a vehicular network and determine a geographic destination of the received first data packet. The instructions may be also stored in the memory may be executable by the processor to forward the first data packet based at least in part on the geographic destination and a current wireless capacity of the vehicular network.

In a fourth set of illustrative examples, a non-transitory computer-readable medium storing instructions executable by a processor is described. The instructions may be executable by the processor to receive a first data packet at a first vehicle in a vehicular network and determine a geographic destination of the received first data packet. The instructions may be further executable by the processor to forward the first data packet based at least in part on the geographic destination and a current wireless capacity of the vehicular network.

The foregoing has outlined rather broadly the features and technical advantages of examples according to the disclosure in order that the detailed description that follows may be better understood. Additional features and advantages will be described hereinafter. The specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purpose of illustration and description only, and not as a definition of the limits of the claims.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 shows a diagram of an example of combined vehicle and wireless communications networks for transferring data in accordance with various embodiments;

FIG. 2 shows a message flow diagram of an example data packet transfer between vehicles in a vehicle network in accordance with various embodiments;

FIG. 3 shows a block diagram of a system for transferring data over combined vehicular and wireless communication networks in accordance with various embodiments;

FIG. 4 shows a block diagram of an example of a data packet that can be transferred over combined vehicular and wireless communication networks in accordance with various embodiments;

FIG. 5 shows a block diagram of an example of an apparatus for transferring data in accordance with various embodiments;

FIG. 6 shows a block diagram of another example of an apparatus for transferring data in accordance with various embodiments;

FIG. 7 shows a block diagram of an example of a routing module for transferring data in accordance with various embodiments;

FIG. 8 shows a block diagram of an example of a vehicle network module for transferring data in accordance with various embodiments;

FIG. 9 shows a diagram of a system for data transfers over combined vehicular and wireless communication networks in accordance with various embodiments;

FIG. 10 shows a block diagram of a system for transferring data in accordance with various embodiments;

FIG. 11 shows a flowchart of an example of a method for wireless communication in accordance with various embodiments; and

FIG. 12 shows a flowchart of another example of a method for wireless communication in accordance with various embodiments.

### DETAILED DESCRIPTION

Vehicles in a vehicular network may receive data packets that may then be either deleted, stored, and/or forwarded. The techniques described herein may be used in a vehicular network to determine which data packet among a plurality of received data packets is to be forwarded in the vehicular network. For example, the data packet may be selected for forwarding according to both the wireless communication capacity and the physical mobility pattern of one or more vehicles based on the geographical destination of the data packet.

Communications in a vehicular network are typically broadcast, and thus may require individual vehicles to determine whether to store, delete, or forward a received data packet. As an example, a vehicle network's wireless capacity may be limited. As such, it may be advantageous for a vehicle to be selective about which data packets it forwards, rather than forwarding every data packet the vehicle receives.

Thus, this disclosure describes methods, apparatuses, and systems for a vehicle to select which data packets to forward in a vehicular network for unicast traffic. As used herein, the term “vehicle” refers to any apparatus, machine, or device that is capable of both physical mobility and wireless communications. The vehicle may receive a plurality of data packets and may have limited bandwidth to forward those data packets. Examples described herein select a data packet for forwarding based on a wireless communication capacity of the vehicular network and may additionally make the selection based on a physical mobility pattern of the vehicle.

For example, the vehicle may review previously received packets stored in a buffer to select whether to forward a packet and if so, which packet to forward. The vehicle may determine a current wireless capacity (or channel load) of the vehicular network within transmission range of the vehicle. The vehicle may also determine a mobility pattern of itself and/or one or more surrounding vehicles. The surrounding vehicles may include any wireless capable vehicle within transmission range of the vehicle.

The vehicle may assign one or more metrics to each stored data packet in order to select which packet to transmit. One metric may be related to whether a geographic destination of the data packet is within transmission range of the vehicle or along the vehicle's route. Another metric may be whether a surrounding vehicle has the geographic destination of the data packet within transmission range along the surrounding vehicle's route. For example, if the vehicle is travelling further from the geographic destination, the vehicle may forward the packet to a surrounding vehicle whose mobility pattern brings the surrounding vehicle closer to the geographic destination and the vehicle network has wireless capacity. Another metric may include a ratio of a current distance between a current geographical location and the geographic destination and the original distance between a location of the source of the data packet and the geographic destination. A further metric may include an expiration time of the data packet. Some examples may include determining two or more of the metrics for two or more of the packets, performing a weighted combination of the metrics, and selecting the data packet with the highest value for forwarding.

In some examples, a packet may only be forwarded if it is determined that the packet is getting off-track to its geographic destination. Higher priority may be given to packets that are getting off-track.

Thus, the following description provides examples, and is not limiting of the scope, applicability, or configuration set forth in the claims. Changes may be made in the function and arrangement of elements discussed without departing from the scope of the disclosure. Various embodiments may omit, substitute, or add various procedures or components as appropriate. For instance, the methods described may be performed in an order different from that described, and various steps may be added, omitted, or combined. Also, features described with respect to certain embodiments may be combined in other embodiments.

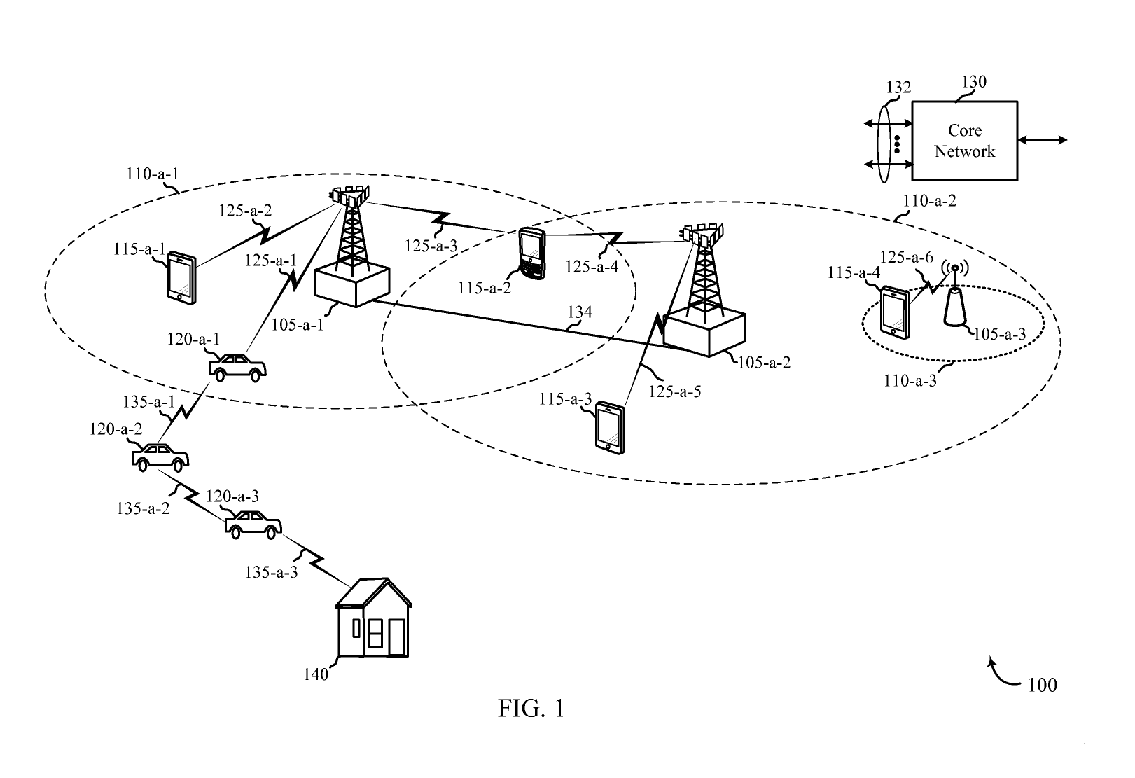

FIG. 1 illustrates an example of a system 100 for data transfers over combined vehicular and wireless communication networks in accordance with various embodiments. The system 100 includes base stations 105 (e.g., base stations 105-a-1, 105-a-2, and 105-a-3), communication devices such as user equipment (UE) devices 115 (e.g., UE devices 115-a-1, 115-a-2, 115-a-3, and 115-a-4) and vehicles 120 (e.g., vehicles 120-a-1, 120-a-2, and 120-a-3), and a core network 130. The base stations 105 may communicate with the UEs 115 and the vehicles 120 under the control of a base station controller, which may be part of the core network 130 or the base stations 105 in various embodiments. Base stations 105 may communicate control information and/or user data with the core network 130 through backhaul links 132. In embodiments, the base stations 105 may communicate, either directly or indirectly, with each other over backhaul links 134. The system 100 may support operation on multiple carriers (waveform signals of different frequencies). Wireless communication links 125 (e.g., links 125-a-1, 125-a-2, 125-a-3, 125-a-4, 125-a-5, and 125-a-6) may be modulated according to various radio technologies. The wireless communication links may be established between the base stations 105 and the UEs 115 and/or the vehicles 120, such as vehicle 120-a-1. Each modulated signal may carry control information (e.g., reference signals, control channels, etc.), overhead information, data, and the like. Wireless communication links 135 (e.g., links 135-a-1, 135-a-2, and 135-a-3) may also be established among vehicles 120 using one or more wireless communication protocols, such as IEEE 802.11p, also known as Dedicated Short Range Communications (DSRC).

In one embodiment, each vehicle 120 may include an apparatus including a receiver, a routing module, and a transmitter, as described in more detail below. Each vehicle 120 may also include a data cache, such as a hard drive, which can be used to exploit the physical movement of the vehicle 120 to transfer data. In this sense, each vehicle 120 can “carry” data, wherever it may go. The vehicles 120 may also be referred to herein as user devices.

The base stations 105 may wirelessly communicate with the UEs 115 and the vehicles 120 via one or more base station antennas. Each of the base station 105 sites may provide communication coverage for a respective coverage area 110 (e.g., coverage area 110-a-1, 110-a-2, and 110-a-3). A coverage area 110 is a geographical area and may also be referred to as a cell. In some embodiments, base stations 105 may be referred to as a base transceiver station, a radio base station, an access point, a radio transceiver, a basic service set (BSS), an extended service set (ESS), a NodeB, eNodeB (eNB), Home NodeB, a Home eNodeB, or some other suitable terminology. The coverage area 110 for a base station 105 may be divided into sectors making up only a portion of the coverage area 110. The system 100 may include base stations 105 of different types (e.g., macro, micro, pico, and/or femto base stations). There may be overlapping coverage areas for different technologies.

The system 100 may be a Heterogeneous LTE/LTE-A network in which different types of base stations 105 provide coverage for various geographical regions. For example, each base station 105 may provide communication coverage for a macro cell, a pico cell, a femto cell, and/or other types of cell. A macro cell generally covers a relatively large geographic area (e.g., several kilometers in radius) and may allow unrestricted access by devices with service subscriptions with the network provider. A pico cell would generally cover a relatively smaller geographic area and may allow unrestricted access by devices with service subscriptions with the network provider. A femto cell would also generally cover a relatively small geographic area (e.g., a home) and, in addition to unrestricted access, may also provide restricted access by devices having an association with the femto cell.

In some embodiments, the system 100 may be heterogeneous in that different base stations 105 may use different wireless communication technologies, and/or a single base station 105 may use a plurality of different wireless communication technologies. For example, one or more base stations 105 may use LTE technology, whereas other base stations may use 802.11n WiFi or 802.11p DSRC technology.

The core network 130 may communicate with the base stations 105 via backhaul links 132 (e.g., S1, etc.). Base stations 105 may communicate control information and/or user data with the core network 130 through backhaul links 132. The base stations 105 may also communicate with one another, e.g., directly or indirectly via backhaul links 134 (e.g., X2, etc.) and/or via backhaul links 132 (e.g., through core network 130). The backhaul links 134 may be wired or wireless communication links. The system 100 may support synchronous or asynchronous operation. For synchronous operation, the base stations 105 may have similar frame timing, and transmissions from different base stations 105 may be approximately aligned in time. For asynchronous operation, the base stations 105 may have different frame timing, and transmissions from different base stations 105 may not be aligned in time. The techniques described herein may be used for either synchronous or asynchronous operations.

A UE 115 or a vehicle 120 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. A UE 115 may be a cellular phone, a personal digital assistant (PDA), a wireless modem, a wireless communication device, a handheld device, a tablet computer, a laptop computer, a cordless phone, a wireless local loop (WLL) station, or the like. A vehicle 120 may be a consumer automobile, a commercial automobile (such as a parcel delivery truck or semi-truck), a non-motorized vehicle such as a bike, a train, an aircraft, and so forth. The vehicle 120 may have a type of vehicle, such as a service vehicle like a taxi, a delivery truck, a bus, a private automobile, or the like. The mobility of the vehicle 120 may be controlled (e.g., a parcel delivery truck may take the same route every day) or uncontrolled (e.g., the owner of a consumer automobile may be free to operate the automobile in any manner he or she sees fit). Notwithstanding the possible uncontrollability of the vehicle 120, there may be some limits in the movement of the vehicle 120—i.e., the vehicle 120 may be constrained to only drive on paved or semi-paved roads, with only minor deviations from established roads being possible (e.g., into parking lots, garages, etc.).

The wireless communication links 125, 135 shown in system 100 may include uplink (UL) transmissions from a UE 115 or vehicle 120 to a base station 105 or to another UE 115 or another vehicle 120, and/or downlink (DL) transmissions. The DL transmissions may be called forward link transmissions while the UL transmissions may be called reverse link transmissions.

The system shown in FIG. 1 may be used in various embodiments of data transfers over combined vehicular and wireless communication networks. For example, the vehicles 120-a-1, 120-a-2, 120-a-3 may together form a vehicular network with physical mobility. The wireless communication links 125, optionally together with the base stations 105 and core network 130, may form a wireless communication network. By combining the vehicular and wireless communication networks in system 100, data transfers between two or more geographically separated areas may be effectuated. For example, as illustrated in FIG. 1, base station 105-a may wirelessly transmit a data packet to a first vehicle 120-a-1. The first vehicle 120-a-1 may then wirelessly transmit the data packet to a second vehicle 120-a-2, and the second vehicle 120-a-2 may wirelessly transmit the data packet to a third vehicle 120-a-3. The third vehicle 120-a-3 may, in turn, transmit the data packet to a stationary node 140. The stationary node 140 may be a roadside unit. In some examples, the stationary node 140 may be a geographic destination of the data packet.

Although FIG. 1 shows the data packet originating from the base station 105-a and ending at the stationary node 140, in other embodiments, the data packet may originate from the stationary node 140, and end at a different stationary node 140, or the data packet may originate from a base station 105 and end at a different base station 105, or the data packet may originate from a stationary node 140 and end at a base station 105. In general, the data packet may be transferred over any number of nodes using the combined vehicular and wireless communication networks in any manner.

The combined vehicular and wireless communication networks in system 100 may form a vehicular backbone network (VBN) which may be used to transfer large amounts of data over both short and long distances. The VBN thus formed may rely on both vehicle-to-vehicle (V2V) and vehicle-to-infrastructure (V2I) communications, with the capacity of data transfer (e.g., speed and volume) determined by the vehicular traffic intensity, the size of the data cache on each vehicle (i.e., how much data each vehicle can carry at any given time), and the wireless communication resources available. Although the use of vehicles 120 to transfer data may introduce a delay as compared to, for example, the nearly instantaneous data transfers made possible by the Internet, there are many applications where such a delay is tolerable or even desirable, such as backup data, or data transfers between large data centers. Furthermore, such a vehicle-based network can be used even in situations where the Internet is not available, such as after a natural disaster that destroys infrastructure, or in underdeveloped areas of the world that may not have a high bandwidth connection to the Internet.

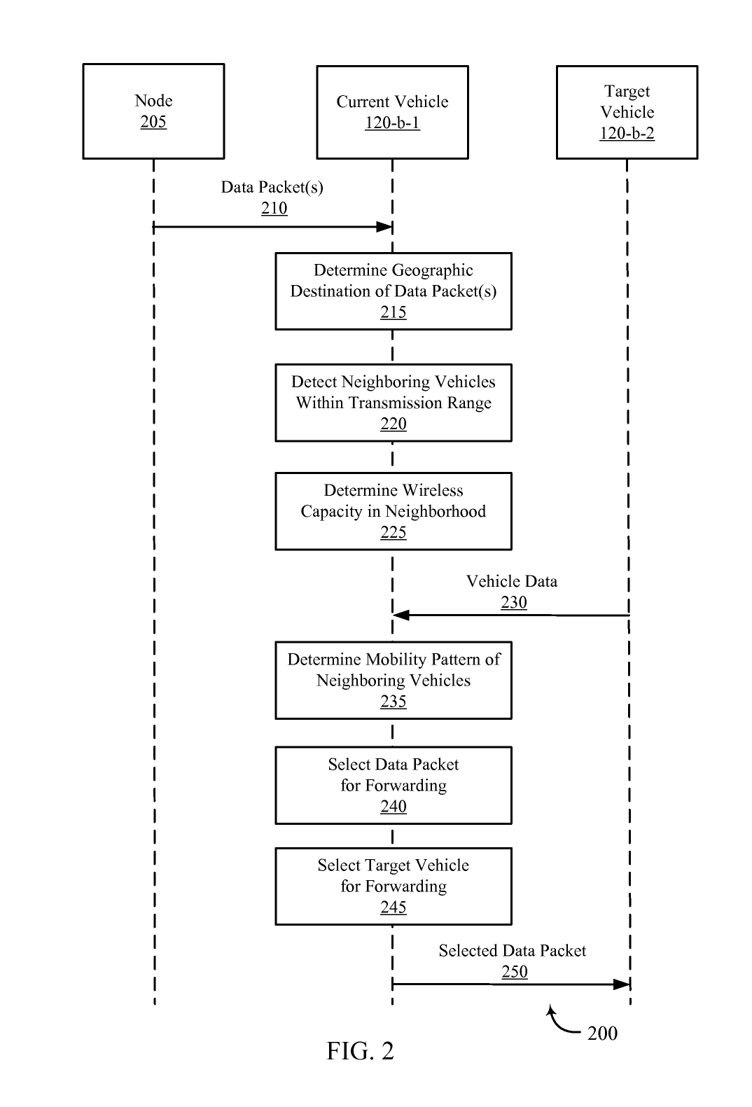

FIG. 2 shows a message flow diagram 200 of an example data packet 210 transfer between vehicles 120-b in a vehicle network in accordance with various embodiments. A node 205 may transfer one or more data packets 210 to a current vehicle 120-b-1. In this example, the current vehicle 120-b-1 ultimately transfers at least one of the one or more data packets 210 to a target vehicle 120-b-2. The vehicles 120-b-1, 120-b-2 may be an example of aspects of one of the vehicles 120 shown in FIG. 1. The node 205 may be an example of aspects of one of the vehicles 120, one of the base stations 105, and/or one of the destination nodes 140 shown in FIG. 1.

The node 205 may broadcast one or more data packets 210 to the current vehicle 120-b-1. In some examples, the node 205 broadcasts the one or more data packets 210 because the node 205 has determined that the current vehicle 120-b-1 may be able to forward at least one of the one or more data packets 210 further towards its destination. In other examples, the node 205 broadcasts the one or more data packets 210 regardless of the current vehicle 120-b-1 being able to receive the one or more data packets 210. The node 205 may broadcast the one or more data packets 210 all at once, separately, or in small groups of data packets broadcasted at different times.

The current vehicle 120-b-1 may receive the one or more data packets 210. In some examples, the current vehicle 120-b-1 determines whether to keep and forward the one or more data packets 210. For example, all nodes 205 and/or vehicles 120 that receive the data packets 210 may have to decide whether to keep the data packets 210 in the storage and whether to forward the data packets 210 by broadcasting them. In some examples, the current vehicle 120-b-1 does not send an acknowledgement for a successful packet transmission. In other examples, the current vehicle 120-b-1 sends an acknowledgement indicating the current vehicle 120-b-1 has received the one or more data packets 210 to the node 205.

If the current vehicle 120-b-1 decides to store the data packets 210 for a potential transmission, the current vehicle 120-b-1 may determine a geographical destination of the data packets 210 at block 215. The geographic destination of a data packet 210 may be a physical location (e.g., an address) or a device for which the data packet 210 is intended. In some examples, the current vehicle 120-b-1 may determine the geographic destination of the data packets 210 before deciding to store at least a subset of the data packets 210 in a buffer.

The current vehicle 120-b-1 may detect one or more neighboring vehicles at block 220. A neighboring vehicle may be any vehicle currently within transmission range of the current vehicle 120-b-1 at the time of detection or expected to be within range at the time of forwarding the data packet. By detecting one or more neighboring vehicles, the current vehicle 120-b-1 determines potential vehicles to which the current vehicle 120-b-1 can transmit one or more of the data packets 210.

The current vehicle 120-b-1 may determine a wireless capacity of the vehicle network in the neighborhood of the current vehicle 120-b-1 at block 225. In determining the wireless capacity of the vehicle network, the current vehicle 120-b-1 may determine a wireless capacity of the vehicle network as a whole, a wireless capacity of the current vehicle 120-b-1 itself, and/or determine a wireless capacity of one or more vehicles within transmission range of the current vehicle 120-b-1. In this example, the target vehicle 120-b-2 is within transmission range of the current vehicle 120-b-1. In determining the wireless capacity of the target vehicle 120-b-2, the target vehicle 120-b-2 may broadcast vehicle data 230 which the current vehicle 120-b-1 receives. The current vehicle 120-b-1 may determine the wireless capacity of the target vehicle 120-b-2 from the vehicle data 230. In other examples, the current vehicle 120-b-1 determines the wireless capacity of the target vehicle 120-b-2 in different ways.

The current vehicle 120-b-1 may determine mobility patterns of at least one neighboring vehicle at block 235. The mobility patterns may include physical mobility information such as current position, current direction, current speed of travel, general vehicular mobility pattern information, transportation traffic intensity information, traffic pattern information, historical transportation traffic intensity information, vehicle type, vehicle route information, vehicle destination, and so forth of one or more neighboring vehicles, such as vehicles 120-a-1, 120-a-2, 120-a-3 in FIG. 1.

Based at least on the geographic destination of the data packets 210 and the mobility patterns of the neighboring vehicles, the current vehicle 120-b-1 may select, at block 240, a data packet for transmission from among the data packets 210. The selection of the data packet may be further based on metrics, as described below. The current vehicle 120-b-1 may also select, at block 245, a target vehicle for forwarding the data packet to from among the neighboring vehicles. In the example of FIG. 2, the current vehicle 120-b-1 selects the target vehicle 120-b-2 to forward the selected data packet 250. The current vehicle 120-b-1 may select the target vehicle 120-b-2 based on at least a current wireless capacity of the target vehicle 120-b-2 and a mobility pattern of the target vehicle 120-b-2.

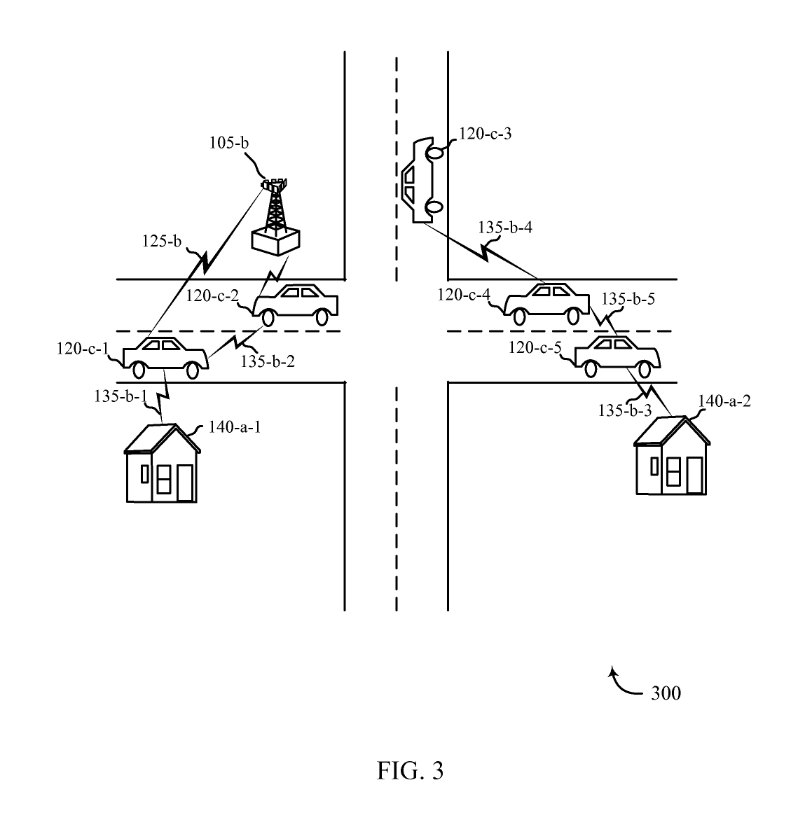

FIG. 3 is an illustration 300 of a system for transferring data over combined vehicular and wireless communication networks, in accordance with various embodiments. FIG. 3 illustrates a plurality of vehicles 120-c-1, 120-c-2, 120-c-3, 120-c-4, 120-c-5, a base station 105-b, and a plurality of wireless communication links 125-b, 135-b-1, 135-b-2, 135-b-3, 135-b-4, 135-b-5 used to transfer data from a source node 140-a-1 to a destination node 140-a-2. The vehicles 120-c-1, 120-c-2, 120-c-3, 120-c-4, 120-c-5 may be examples of the vehicles 120-a, 120-b and the base station 105-b may be an example of the base stations 105 and/or the node 205 described above with reference to FIGS. 1 and/or 2.

In one example, a data packet (or a plurality of data packets) to be transferred is uploaded from source node 140-a-1 to a first vehicle 120-c-1 using wireless communication link 135-b-1. The vehicle 120-c-1 receives data from another vehicle 120-c-2 over the wireless communication link 135-b-2 and from the base station 105-b over the wireless communication link 125-b, which information may include mobility and/or traffic information. The vehicle 120-c-1 may also directly measure mobility and/or traffic information using one or more sensors.

During transit, the vehicle 120-c-1 may need to wirelessly transmit information to one or more other vehicles, or to a stationary node, in order for the data packet to be transferred to destination node 140-a-2. As illustrated in FIG. 3, there are generally two types of wireless transfers between vehicles that may occur during the data transfer operation. For example, a vehicle 120-c-3 may wirelessly transmit a data packet to another vehicle 120-c-4 using wireless communications link 135-b-4 at an intersection (which may be called “intersection switching”). Also, a vehicle 120-c-4 may wirelessly transmit a data packet to another vehicle 120-c-5 using wireless communications link 135-b-5 on a single road segment (which may be called “u-turn switching”). Ultimately, once a vehicle carrying the data packet arrives within wireless communication range (e.g., transmission range) of the destination node 140-a-2, the vehicle 120-c-5 may use wireless communications link 135-b-3 to wirelessly transmit the data packet to the destination node 140-a-2. It will be noted that the simplified example given in FIG. 3 is merely illustrative, and that many more segments and wireless switching between vehicles may be needed for any given data packet to reach its intended destination node.

In some embodiments, the wireless spectrum available for wireless data transfers may need to be shared if two or more vehicles 120 are close enough to one another. Such sharing of the wireless spectrum may reduce the speed at which some data can be transferred, including the data transfers from the source node 140-a-1 to the first vehicle 120-c-1 on the data transfer path, from the last vehicle 120-c-5 on the data transfer path to the destination node 140-a-2, intersection switching data transfers, and/or u-turn switching data transfers. In some embodiments carrier sense multiple access (CSMA) techniques may be employed to help reduce interfering transmissions on the shared wireless spectrum.

In one embodiment, each vehicle 120 may maintain a routing decision table for each destination and each intersection. The routing decision table may be computed based on vehicle traffic and data traffic statistics, and may be distributed to the vehicles 120 periodically in a relatively slow time scale. When a vehicle passes a road intersection, it may look up its routing decision table and possibly wirelessly transmit one or more data packets to vehicles on neighboring road segments chosen by the routing decision (i.e., intersection switching). Similarly, when a vehicle is traveling away (e.g., in the opposite geographical direction) from the data packet destination, the vehicle may wirelessly transfer one or more data packets, based on routing decisions, to vehicles that are moving in the opposite direction (i.e., u-turn switching). The routing decisions may be further based on metrics of the data packets to be transferred and on a wireless capacity (or channel load) of the vehicle network. Even if the vehicle 120 is not traveling “away” from the destination, u-turn switching may be used if it is determined that movement in the opposite direction is preferable. The wireless spectrum allocated to u-turn switching may be the same or different than wireless spectrum allocated to loading/unloading and intersection switching.

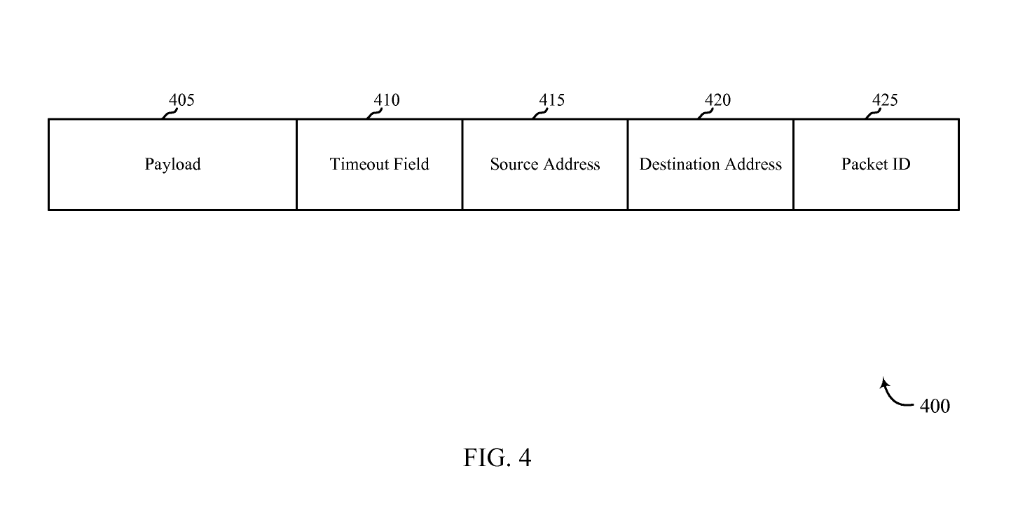

FIG. 4 shows a block diagram of an example of a data packet 400 that can be transferred over combined vehicular and wireless communication networks in accordance with various embodiments. The data packet 400 may be examples of the data packets 210 and 250 described above with reference to FIGS. 1, 2, and/or 3.

The data packet 400 may include a payload 405 that contains the body data of the data transmission. That is, the payload 405 may be the data desired to be transmitted via the transmission. The data packet 400 may further include a timeout field 410. The timeout field 410 may identify a time by which the data packet 400 is considered to be expired. Alternatively, the timeout field 410 may include a duration of time, at which the expiration thereof, the data packet 400 is considered to be expired. When the data packet 400 is expired, a device storing the data packet 400 for transmission, such as a vehicle 120, may delete the data packet 400. In some examples, the vehicle 120 may not transmit the data packet 400 after the expiration of the timeout field 410.

The data packet 400 may also include a source address 415 and a destination address 420. The source address 415 may identify an address or source node that originated the data packet 400. In other examples, the source address 415 may identify the device that transmitted the data packet 400 to the current holder of the data packet, such as the current vehicle 120-b-1 of FIG. 2. The destination address may identify a geographical destination of the data packet 400. A current vehicle storing the data packet 400 may determine the geographic destination of the data packet 400 by reading the destination address 420. In some examples, the geographical destination is a physical address, and in other examples, the geographic destination is actually a particular device or node for which the data packet 400 is intended. The data packet 400 may also contain a packet identification (ID) 425 which uniquely identifies the data packet 400.

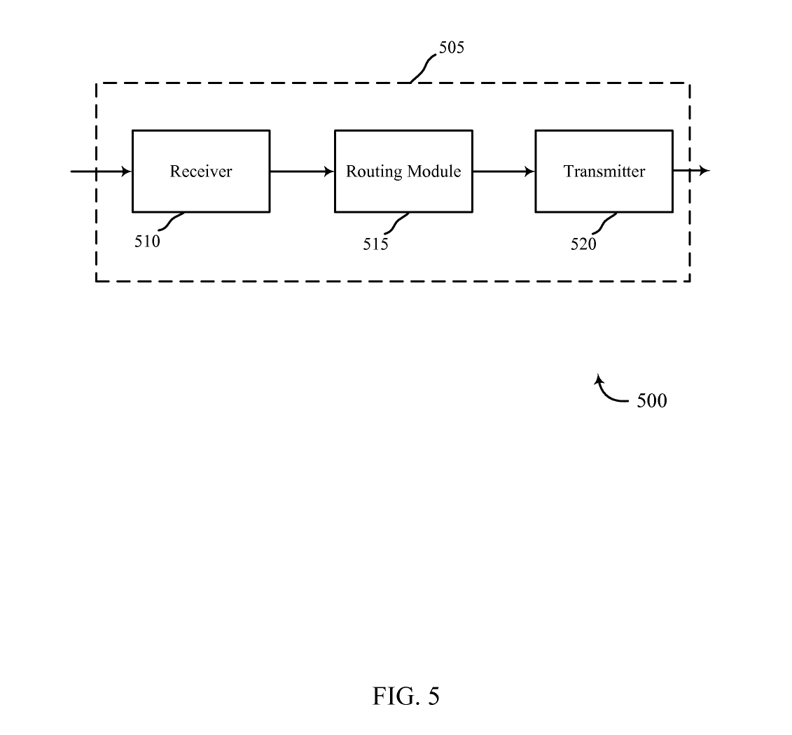

FIG. 5 shows a block diagram 500 of an example of an apparatus 505 for transferring data in accordance with various embodiments. The apparatus 505 may participate in the transfer of one or more data packets, such as a data packet 210, 250, 400 of FIGS. 2 and 4. The apparatus 505 may be, for example, one of the vehicles 120 shown in FIGS. 1-3, or may be one of the base stations 105 shown in FIGS. 1 and/or 3 or node 205 shown in FIG. 2. The apparatus 505 shown in FIG. 5 includes a receiver 510, a routing module 515, and a transmitter 520. Each of these components may be in communication with each other.

The receiver 510 may receive information such as packets, user data, vehicle data, and/or control information associated with various information channels (e.g., control channels, data channels, etc.). Information may be passed on to the routing module 515, and to other components of the apparatus 505. For example, the receiver 510 may, in addition to receiving data packets that are to be transferred between two geographically separate locations, also receive information regarding one or more vehicles, such as vehicles 120 in FIG. 1, including physical mobility information such as current position, current direction, current speed of travel, wireless network capacity or channel load, vehicle type, general vehicular mobility pattern information, transportation traffic intensity information, traffic pattern information, historical transportation traffic intensity information, and so forth. The receiver 510 may also receive information regarding maps, road segments (corresponding to available routes for the data packet to take to reach a given destination). The receiver 510 may receive packets and information over one or more wireless communication links—for example, Long Term Evolution (LTE), WiFi, DSRC, and so forth—or in the case where the apparatus 505 is a base station, may also receive information over a wired link from the core network 130.

The routing module 515 may be configured to identify a data packet at a source. The source may be a vehicle or a stationary transmitter in some embodiments, and the routing module 515 may identify the data packet by receiving the data packet, by receiving current mobility information associated with a vehicle carrying the data packet, by receiving a request to transfer the data packet, and so forth. When the routing module 515 is deployed in a source, the routing module 515 may also be configured to determine whether to wirelessly transmit the data packet from the source to a target vehicle based at least in part on a wireless capacity and a mobility pattern associated with the target vehicle. The target vehicle may be another vehicle in some embodiments, and, if the target is the ultimate destination of the data packet, then the routing module 515 may be configured to transmit the data packet to a stationary node, such as a base station or a home or office. In examples where the routing module 515 is deployed in one of the vehicles 120, the routing module 515 may be configured to identify the data packet and the source that sent the data packet to the vehicle 120.

In one example, the source may be a stationary transmitter, such as a home or office needing to transfer the data packet to a geographically separate location. The target vehicle may be a vehicle that is near the home or office (e.g., within range of wireless communications) and available to transport the data packet to the geographically separate location. In another example, the source may be a first vehicle, with the target vehicle being a second vehicle, separate from the first vehicle. This may be the case, for example, in instances where the data packet is being switched between vehicles in between the originating geographic location of the data packet and ultimate geographic destination for the data packet, as will be described in more detail below.

The transmitter 520 may transmit one or more signals received from other components of the apparatus 505. For example, the transmitter 520 may transmit a data packet that the apparatus 505 has received, and/or the transmitter 520 may transmit information to one or more vehicles or to a network infrastructure associated with the combined vehicular and wireless communication networks. In some embodiments, the transmitter 520 may be collocated with the receiver 510 in a transceiver module. The transmitter may transmit packets and information over one or more wireless protocols—for example, LTE, Wi-Fi, DSRC, and so forth.

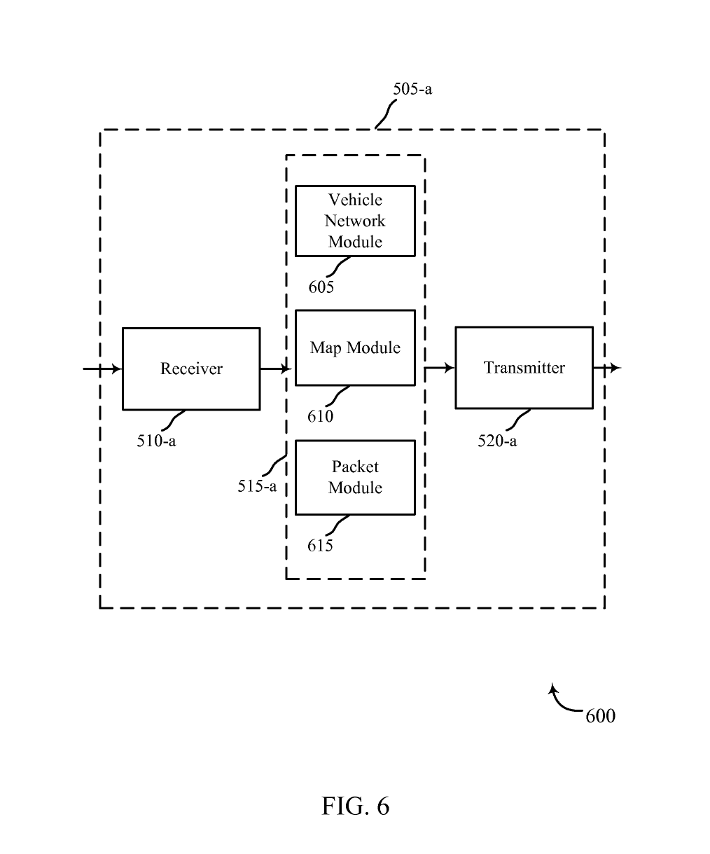

FIG. 6 shows a block diagram 600 of another example of an apparatus 505-a for transferring data in accordance with various embodiments. The apparatus 505-a may be, for example, one of the vehicles 120 shown in FIGS. 1-3 and may be an example of one or more aspects of the apparatus 505 described with reference to FIG. 5. The apparatus 505-a shown in FIG. 6 includes a receiver 510-a, a routing module 515-a, and a transmitter 520-a. Each of these components may be in communication with each other. The routing module 515-a in FIG. 6 includes a vehicle network module 605, a map module 610, and a packet module 615.

The receiver 510-a may receive information such as packets, vehicle data, user data, and/or control information associated with various information channels (e.g., control channels, data channels, etc.), as described above with reference to FIG. 5. Information may be passed on to the routing module 515-a and to other components of the apparatus 505-a. The routing module 515-a may be configured to perform the operations described above with reference to the routing module 515 shown in FIG. 5. The transmitter 520-a may transmit the one or more signals received from other components of the apparatus 505-a, as described above with reference to FIG. 5.

The vehicle network module 605, the map module 610, and the packet module 615 may each be configured to receive, provide, and/or analyze information to aid in selection of a data packet to transmit and in determining whether to wirelessly transmit the selected data packet from the source to a target vehicle. The vehicle network module 605 may, for example, receive, provide, and/or analyze information related to the wireless capacity and mobility of one or more vehicles, including their channel load, wireless capabilities, location, direction of travel, speed of travel, vehicle type, predetermined route, destination, and so forth. In one embodiment, the vehicle network module 605 may heuristically predict an anticipated direction of travel as well. The map module 610 may receive, provide, and/or analyze information related to the geographic location of one or more vehicles (such as a vehicle currently carrying a data packet, and vehicles within wireless communication range of that vehicle that could receive the data packet), the geographic location of the ultimate destination of the data packet, possible routes or segments vehicles and the data packet may take in reaching the ultimate destination, and so forth. The packet module 615 may receive, provide, and/or analyze information related to a geographic destination of the data packets stored at the apparatus 505-a and one or more metrics for each of the stored data packets. Some or all of the information provided and/or analyzed by the vehicle network module 605, the map module 610, and the packet module 615 may be used to determine whether to wirelessly transmit the data packet to a target vehicle.

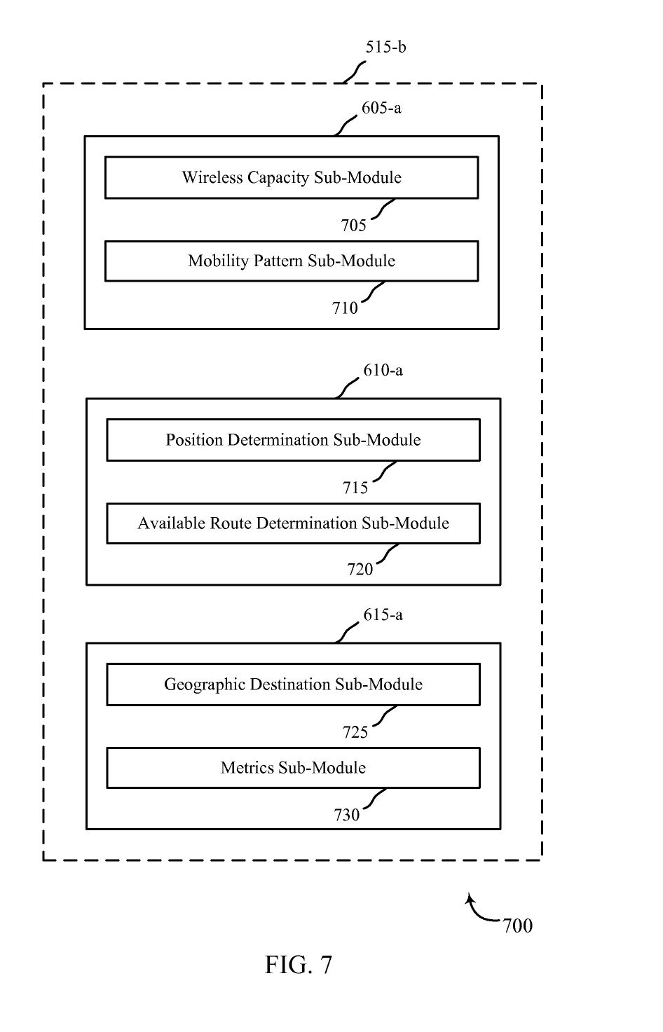

FIG. 7 shows a block diagram 700 of an example of a routing module 515-b for transferring data in accordance with various embodiments. The routing module 515-b may be an example of one or more aspects of the routing modules 515 described with reference to FIGS. 5 and/or 6, and may be configured to perform the operations described above with reference to FIGS. 5 and/or 6. The routing module 515-b in FIG. 7 includes a vehicle network module 605-a, a map module 610-a, and a packet module 615-a.

The vehicle network module 605-a shown in FIG. 7 may further include a wireless capacity sub-module 705 and a mobility pattern sub-module 710. The wireless capacity sub-module 705 may check a current wireless capacity (or channel load) in the neighborhood of the routing module 515-b (e.g., within the transmission range of the current vehicle). The wireless capacity sub-module 705 may determine the wireless capacity of vehicles in the neighborhood based on a channel busy ratio for Wi-Fi communications. The channel busy ratio may indicate a fraction of a busy period on the channel. In another example, the wireless capacity sub-module 705 receives information regarding the channel load in the current network and/or one or more particular vehicles in the geographical vicinity of the current vehicle through communicating with infrastructure of the network. For example, the wireless capacity sub-module 705 may receive information regarding wireless capacity from a roadside unit with backhaul, such as a stationary node 140 of FIG. 1, or directly to an entity in the cloud via a wide access network (WAN). As described herein, a measurement of a wireless capacity is used for a determination of whether the vehicle network has wireless capacity to handle forwarding a particular data packet.

The mobility pattern sub-module 710 may be configured to determine and/or analyze the mobility patterns for one or more vehicles. The mobility pattern sub-module 710 may determine the mobility pattern of the current vehicle and surrounding vehicles by checking the vehicle type and service route of the vehicles. For example, the mobility pattern sub-module 710 may determine mobility patterns for one or more neighboring vehicles to which the data packet may be transmitted located within transmission range of a current vehicle that is currently carrying a data packet and/or the mobility pattern of the current vehicle. The mobility pattern sub-module 710 may further determine a route and a destination of the target vehicle. In some examples, the current vehicle or the target vehicle may have a predictable route (e.g., buses serving a known route, postal delivery service vehicles on route or heading back to the station, a taxi travelling to pick up a passenger at a certain location, etc.). In other examples, it may be difficult to determine the mobility pattern for some vehicles. In such a case, those vehicles may be treated as entities randomly moving in the vehicle network without much mobility predictability.

The mobility pattern sub-module 710 may include or receive information from a positioning system, such as a Global Positioning System (GPS) device associated with one or more vehicles. For example, sub-module 710 may receive information from GPS devices coupled to each vehicle. The mobility pattern sub-module 710 may also include or receive information from an on-board navigation system. For example, the mobility pattern sub-module 710 may determine a destination of the vehicle based on a user-inputted destination to the on-board navigation system.

In some examples, the mobility pattern sub-module 710 may also determine a mobility pattern using historical driving patterns for the particular vehicle (e.g., a driver may be likely to be driving home or to a place of work based on historical data from previous trips). That is, the mobility pattern sub-module 710 may be configured to analyze historical mobility information for one or more vehicles. For example, the mobility pattern sub-module 710 may use a database of previous mobility information for one or more vehicles to help predict future mobility for one or more vehicles.

The map module 610-a in FIG. 7 may include a position determination sub-module 715 and an available route determination sub-module 720. The position determination sub-module 715 may be configured to determine and/or analyze the current position of one or more vehicles, such as a vehicle that is currently carrying a data packet and/or one or more target vehicles to which the data packet may be transmitted. The current position may be obtained using information from a positioning system, such as a GPS device. The available route determination sub-module 720 may be configured to analyze a database, such as a digital map, to determine possible routes that a given vehicle or a corresponding data packet may take. For example, the available route determination sub-module 720 may, based on a current location of a vehicle carrying a data packet (obtained, in one embodiment, from the position determination sub-module 715), propose one or more possible routes for consideration when determining whether to wirelessly transmit a data packet from a source to a target vehicle.

The packet module 615-a in FIG. 7 may include a geographic destination sub-module 725 and a metrics sub-module 730. The geographic destination sub-module 725 may be configured to determine and/or analyze a geographic destination of one or more data packets received at the current vehicle. The geographic destination sub-module 725 may determine the geographic destination using a packet ID or a destination address included in the packet, such as data packet 400 of FIG. 4.

The metrics sub-module 730 may be configured to determine metrics for one or more data packets stored at and available for transmission to the current vehicle. The metrics sub-module 730 may use information from the mobility pattern sub-module 710 and/or the map module 610-a for these determinations. For each data packet stored at the current vehicle, the metrics sub-module 730 may determine whether the data packet has a geographical destination that is within transmission distance of the current vehicle and its wireless communication capability. If this is true for a data packet, the metrics sub-module 730 may select that data packet for transmission to its geographical destination if the network has wireless capacity for the transmission.

For the rest of the data packets, the metrics sub-module 730 may determine whether the data packet has a geographical destination which is on the mobility (or service) route of the current vehicle or any of the surrounding vehicles. If one of the surrounding vehicles has the geographic destination of the data packet along its route, the metrics sub-module 730 may select that data packet for transmission to that target vehicle if the target vehicle has wireless capacity for the transmission. In one example, if the current vehicles has the geographic destination of the data packet along its route, the metrics sub-module 730 may select that data packet for transmission to the geographic destination when the current vehicle is within transmission range of the geographic destination and has wireless capacity for the transmission.

For any data packets that do not fit within the above described scenarios, the metrics sub-module 730 may calculate a ratio of a current distance between the current geographical location and the geographic destination of the data packet and the original distance between the packet source location and the geographic destination of the data packet. The metrics sub-module 730 may further check an expiration time of the data packet. The metrics sub-module 730 may determine the expiration time using a timeout field included in the packet, such as the timeout field 410 of the data packet 400 shown in FIG. 4. If the data packet has expired, the metrics sub-module 730 may assign the data packet a very low value (e.g., a value of 0) or may even delete, or cause the deletion of, the data packet.

The metrics sub-module 730 may assign a metric to each of the data packets. In some examples, metrics sub-module 730 assigns the metric based on all the above described factors (e.g., geographic destination within transmission range of current vehicle, geographic destination within transmission range of wireless network, geographical destination on the mobility or service route of any of a neighboring vehicle, the ratio, and the expiration time of the data packet).

The metrics sub-module 730 may rank the data packets in one example as follows. A data packet with larger ratio and with a timer closer to expiration may get a higher value for the metric. A data packet arriving at its destination or the having a predictable carrier and/or vehicle that would bring the data packet closer to its destination gets a higher value. An example metric may be as follows:

$${M}_{p} = {D}_{1} {B}_{1} + {D}_{2} {B}_{2} + \frac{C}{O} + \frac{1}{T} \qquad ( 1 )$$

where Mₚ is a metric value for a given packet, D₁ is an indicator that the packet is arriving at the geographic destination, D₂ is an indicator that the packet is within the vicinity of at least one vehicle heading to the geographic destination, B₁ and B₂ are weight coefficients, C is the current route distance (e.g., a current distance between the current geographical location and the geographic destination of the data packet), O is the original route distance (e.g., an original distance between the packet source location and the geographic destination of the data packet), and T is time to expiration of the data packet. The weight coefficients B₁ and B₂ may be the same or different. In other examples, the metrics sub-module 730 includes other or fewer factors in determining the metric values for each data packet.

The metrics sub-module 730 may further select a data packet for transmission based at least in part on the metrics. For example, the metrics sub-module 730 may select the data packet with the highest metric value to transmit. The metrics sub-module 730 may also select a transmission priority, i.e., CSMA backoff counter for Wi-Fi, based at least in part on the metric values.

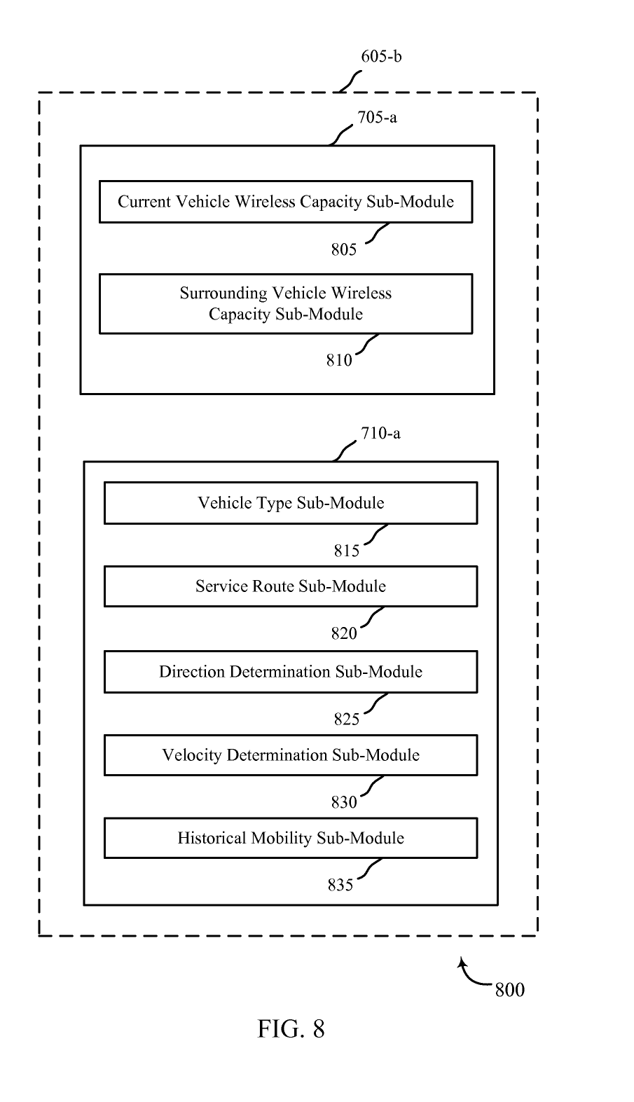

FIG. 8 shows a block diagram 800 of an example of a vehicle network module 605-b for transferring data in accordance with various embodiments. The vehicle network module 605-b may be an example of one or more aspects of the vehicle network module 605 described with reference to FIGS. 6 and/or 7, and may be configured to perform the operations described above with reference to FIGS. 6 and/or 7. The vehicle network module 605-b in FIG. 8 includes a wireless capacity sub-module 705-a and a mobility pattern sub-module 710-a. The wireless capacity sub-module 705-a and the mobility pattern sub-module 710-a may be examples of one or more aspects of the wireless capacity sub-module 705 and the mobility pattern sub-module 710 of FIG. 7, respectively.

The wireless capacity sub-module 705-a shown in FIG. 8 further includes a current vehicle wireless capacity sub-module 805 and a surrounding vehicle wireless capacity sub-module 810. The current vehicle wireless capacity sub-module 805 may determine a wireless capacity of the vehicle carrying a data packet to be transmitted and/or one or more surrounding vehicles. The wireless capacity of the vehicle may be, for example, signal power, potential transmission rates, and/or bandwidth. In some examples, the current vehicle wireless capacity sub-module 805 models a wireless capacity of one or more vehicles based on information including distance between two vehicles, transmission rate of the vehicle and surrounding vehicles, signal power of the vehicle and surrounding vehicles, in order to calculate the wireless capacity. In some examples, the current vehicle wireless capacity sub-module 805 determines the wireless capacity for a group of nodes (e.g., vehicles) within a range of the apparatus 505, such as the transmission range. The current vehicle wireless capacity sub-module 805 and the surrounding vehicle wireless capacity sub-module 810 may provide the information related to the wireless capacity of vehicles in the vehicle network to other components of the routing module, such as the routing module 515 of FIGS. 5-7.

The mobility pattern sub-module 710-a shown in FIG. 8 further includes a vehicle type sub-module 815, a service route sub-module 820, a direction determination sub-module 825, a velocity determination sub-module 830, and a historical mobility sub-module 835. The vehicle type sub-module 815 may determine what type of vehicle a neighboring vehicle is, such as whether it is a service vehicle (e.g., a delivery vehicle or bus) or a consumer vehicle. The service route sub-module 820 may determine a designated route of the vehicle if the vehicle is a service vehicle. The direction determination sub-module 825 may be configured to determine and/or analyze the direction of travel for one or more vehicles. Similarly, the velocity determination sub-module 830 may be configured to determine and/or analyze the speed of travel for one or more vehicles, such as the speed of a vehicle currently carrying a data packet, or one or more target vehicles to which the data packet may be transmitted. The historical mobility sub-module 835 may be configured to analyze historical mobility information for one or more vehicles. For example, the historical mobility sub-module 835 may use a database of previous mobility information for one or more vehicles to help predict future mobility for one or more vehicles. The sub-modules 815, 820, 825, 830, 835 may include or receive information from a positioning system, such as a GPS device associated with one or more vehicles. For example, sub-modules 815, 820, 825, 830, 835 may receive information from GPS devices coupled to each vehicle.

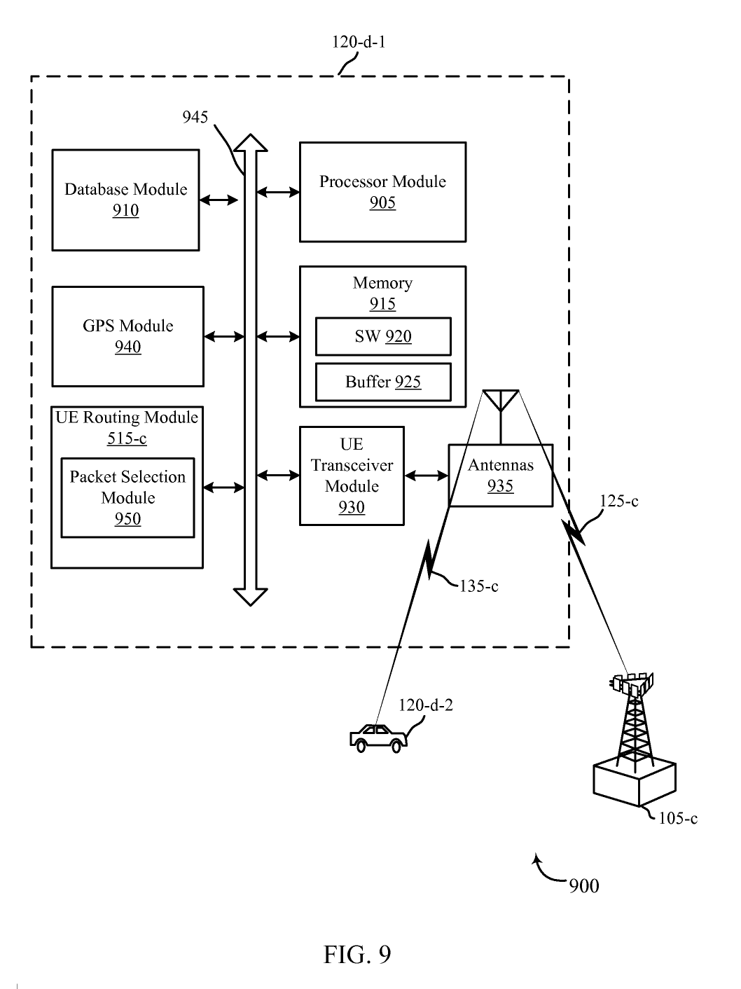

FIG. 9 shows a diagram of a system 900 for data transfers over combined vehicular and wireless communication networks in accordance with various embodiments. System 900 includes vehicles 120-d-1, 120-d-2 which may be examples of the vehicles 120 in FIGS. 1-3 and/or the apparatuses 505 in FIGS. 5-7. System 900 also includes a base station 105-c, which may be an example of the base station 105 in FIGS. 1 and/or 3, the node 205 in FIG. 2, and/or the apparatuses 505 of FIGS. 5-7.

The vehicle 120-d-1 shown in FIG. 9 includes antenna(s) 935, a UE transceiver module 930, a processor module 905, and memory 915 (including software (SW) 920 and buffer 925), which each may communicate, directly or indirectly, with each other (e.g., via one or more buses 945). The UE transceiver module 930 may be configured to communicate bi-directionally, via the antenna(s) 935 and/or one or more wireless communication links, with one or more other vehicles 120-d-2, one or more base stations 105-c or other nodes, as described above. The UE transceiver module 930 may include a modem configured to modulate the packets and provide the modulated packets to the antenna(s) 935 for transmission, and to demodulate packets received from the antenna(s) 935. While the vehicle 120-d-1 may include a single antenna 935 in some embodiments, the vehicle 120-d-1 may alternatively have multiple antennas 935 capable of concurrently transmitting and/or receiving multiple wireless transmissions. The UE transceiver module 930 may thus be capable of concurrently communicating with one or more base stations 105-c and/or one or more other vehicles 120-d-2. The vehicle 120-d-1 may exchange data with the vehicle 120-d-2 over a wireless communication link 135-c. The vehicle 120-d-1 may also exchange data with the base station 105-c over the wireless communication link 125-c.

The memory 915 may include random access memory (RAM) and/or read-only memory (ROM). The memory 915 may store computer-readable, computer-executable software 920 containing instructions that are configured to, when executed, cause the processor module 905 to perform various functions described herein (e.g., analyzing received information). Alternatively, the software 920 may not be directly executable by the processor module 905 but be configured to cause a computer (e.g., when compiled and executed) to perform functions described herein. The processor module 905 may include an intelligent hardware device, e.g., a central processing unit (CPU) such as an ARM® based processor or those made by Intel® Corporation or AMD®, a microcontroller, an application-specific integrated circuit (ASIC), etc. may include random access memory (RAM) and read-only memory (ROM). The memory 915 may include the buffer 925, which may store one or more data packets for transfer by the vehicle 120-d-1. In some embodiments, the memory 915 may include or be implemented as a hard drive.

The vehicle 120-d-1 also includes a database module 910, a GPS module 940, and a routing module 515-c, each of which may be coupled to bus 945 in order to allow communication with the other components of the vehicle 120-d-1. The database module 910 may include one or more databases, such as a map database, a road database, a historical information database, an optimization function database, and so forth. The database module 910 may be configured to provide the routing module 515-c with access to its databases for use in determining resource allocations, such as whether a particular vehicle should or should not wirelessly transmit a data packet to a different vehicle or to a stationary node.

The GPS module 940 may include a GPS receiver configured to receive GPS signals and determine position, speed, timing, and other mobility information associated with the vehicle 120-d-1 (including both current and past data), which can also be provided to the routing module 515-c.

The routing module 515-c may be an example of the routing modules 515 shown in FIGS. 5-7, and may include an example of the vehicle network module 605-b of FIG. 8, and may include a packet selection module 950. The routing module 515-c may be configured to make a resource allocation, such as determining whether the vehicle 120-d-1 should wirelessly transmit, via the UE transceiver module 930 and the antenna(s) 935, a data packet stored in the buffer 925 in the memory 915 to another vehicle 120-d-2 or to a stationary node, such as base station 105-c. The packet selection module 950 in the routing module 515-c may be configured to select a data packet from a plurality of data packets for transmission to another vehicle or to a stationary node. For example, the packet selection module 950 may, at a given time slot, go over each packets stored in the buffer 925 to select whether to forward a data packet and if so, which data packet to forward. In determining which data packet to select, the packet selection module 950 may use, for example, metrics assigned for each of the plurality of data packets. The packet selection module 950 may assign metrics to each data packet based at least in part on the metric and the ranking process describe with respect the metrics sub-module 730 of FIG. 7.

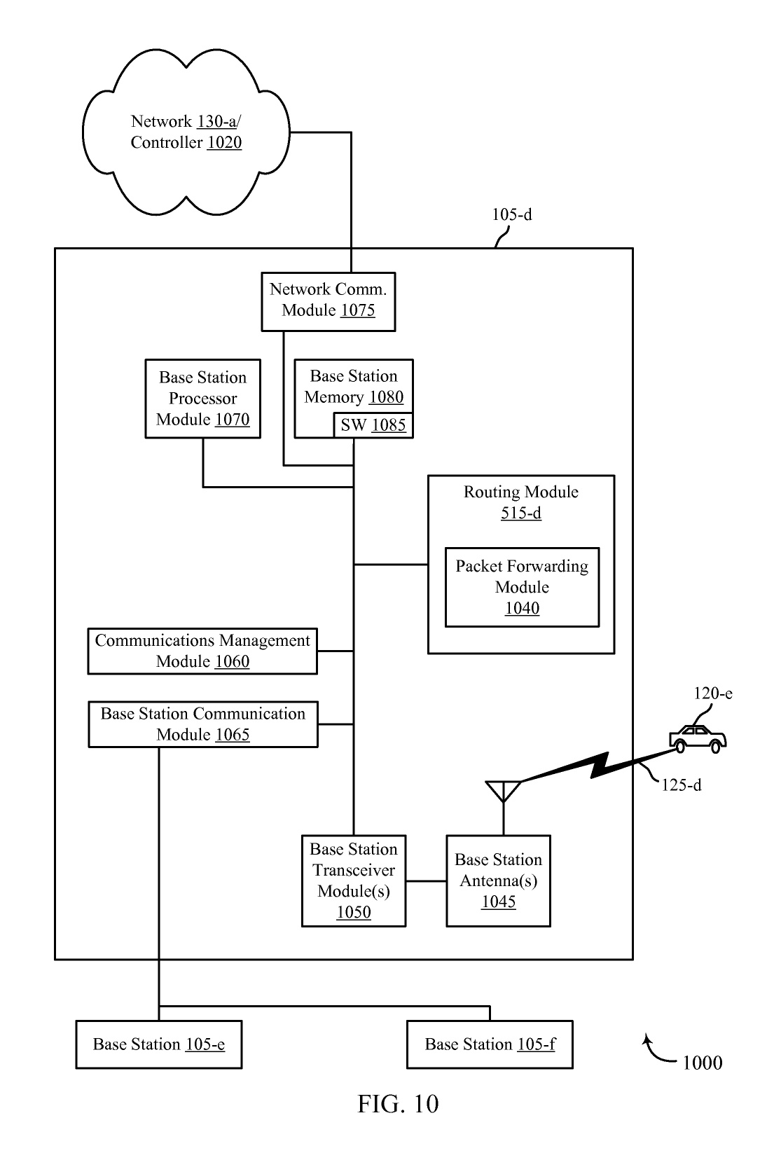

FIG. 10 shows a block diagram of a system 1000 for transferring data in accordance with various embodiments. System 1000 includes base stations 105-d, 105-e, 105-f, which may be examples of the base stations 105 in FIGS. 1, 3, and/or 9, the node 205 in FIG. 2, and/or the apparatus 505 in FIGS. 5-7. System 1000 also includes a vehicle 120-e, which may be an example of the vehicles 120 in FIGS. 1-3, and/or the apparatuses 505 in FIGS. 5-7.

The base station 105-d may include base station antenna(s) 1045, base station transceiver module(s) 1050, base station memory 1080, and a base station processor module 1070, which each may be in communication, directly or indirectly, with each other (e.g., over one or more buses). The base station transceiver module(s) 1050 may be configured to communicate bi-directionally, via the base station antenna(s) 1045, with the vehicle 120-e, as well as other vehicles, over communication link 125-d. The base station transceiver module(s) 1050 (and/or other components of the base station 105-d) may also be configured to communicate bi-directionally with one or more networks. In some cases, the base station 105-d may communicate with the core network 130-a and/or controller 1020 through network communications module 1075. The base station 105-d may be an example of an eNodeB base station, a Home eNodeB base station, a NodeB base station, and/or a Home NodeB base station. The controller 1020 may be integrated into base station 105-d in some cases, such as with an eNodeB base station.

The base station 105-d may also communicate with other base stations 105, such as base station 105-e and base station 105-f. Each of the base stations 105 may communicate with one or more vehicles using different wireless communications technologies, such as different Radio Access Technologies. In some cases, base station 105-d may communicate with other base stations such as 105-e and/or 105-f utilizing base station communication module 1065. In some embodiments, base station communication module 1065 may provide an X2 interface within an LTE wireless communication technology to provide communication between some of the base stations 105. In some embodiments, the base station 105-d may communicate with other base stations through controller 1020 and/or core network 130-a.

The base station memory 1080 may include random access memory (RAM) and read-only memory (ROM). The base station memory 1080 may also store computer-readable, computer-executable software code 1085 containing instructions that are configured to, when executed, cause the base station processor module 1070 to perform various functions described herein (e.g., call processing, database management, message routing, etc.). Alternatively, the software code 1085 may not be directly executable by the base station processor module 1070 but may be configured to cause the computer, e.g., when compiled and executed, to perform functions described herein. The base station memory 1080 may also act as a data cache for one or more data packets to be transferred. For example, if a vehicle reaches a certain point, and there are no other vehicles to transfer the data packet to, the vehicle may transfer the data packet to the base station 105-d, which may store the data packet in the base station memory 1080.

The base station processor module 1070 may include an intelligent hardware device, e.g., a central processing unit (CPU), a microcontroller, an application-specific integrated circuit (ASIC), etc. The base station transceiver module 1050 may include a modem configured to modulate the packets and provide the modulated packets to the antenna(s) 1045 for transmission, and to demodulate packets received from the antenna(s) 1045. While some examples of the base station 105-d may include a single antenna 1045, the base station 105-d may include multiple antennas 1045 for multiple links which may support carrier aggregation. For example, one or more links may be used to support macro communications with mobile vehicles 120.

According to the architecture of FIG. 10, the base station 105-d may further include a communications management module 1060. The communications management module 1060 may manage communications with other base stations 105. By way of example, the communications management module 1060 may be a component of the base station 105-d in communication with some or all of the other components of the base station 105-d via a bus. Alternatively, functionality of the communications management module 1060 may be implemented as a component of the base station transceiver module 1050, as a computer program product, and/or as one or more controller elements of the base station processor module 1070.

The base station 105-d in FIG. 10 also includes a routing module 515-d, which may be an example of the routing modules 515 shown in FIGS. 5-7. The routing module 515-d in FIG. 10 may include a packet forwarding module 1040. The packet forwarding module 1040 may forward one or more packets to one or more vehicles 120, such as to vehicle 120-e.

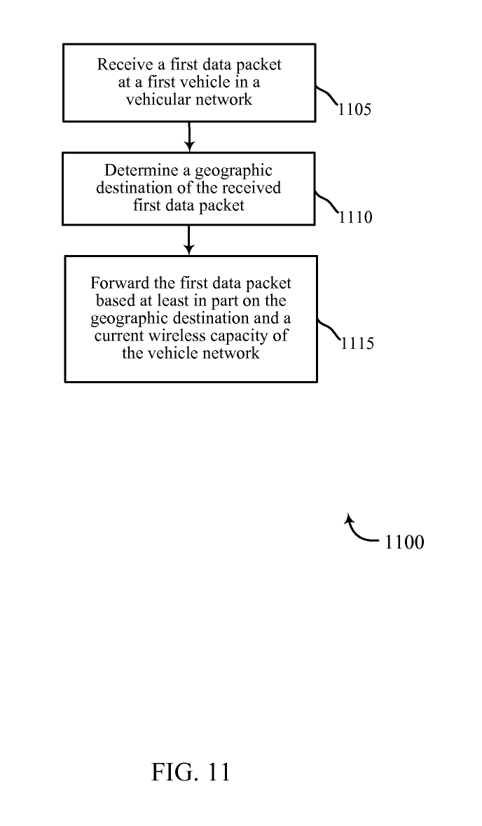

FIG. 11 shows a flowchart of an example of a method 1100 for wireless communication in accordance with various embodiments. The functions of the method 1100 may be implemented by an apparatus 505 as described above with reference to FIGS. 5-7 and/or 9 and/or a vehicle 120 as described above with reference to FIGS. 1-3 and/or 9, or any combination of these or any one of their components.

At block 1105, a first data packet may be received at a first vehicle in a vehicular network. The first vehicle may be a vehicle 120 and may have received the first data packet from a source. The source may be a stationary node or may be a vehicle. The data packet may be an example of the data packet 400 as described above with reference to FIG. 4. The data packet may be identified in one or more of several different ways. For example, the data packet may be identified because it was received in response to a query, from additional information received regarding the data packet (e.g., which vehicle is carrying the data packet and mobility information associated with that vehicle), from the particular data packet being queued for transmission, and so forth.

At block 1110, a geographic destination of the received first data packet is determined. The geographic destination of the first data packet may be determined from a destination address or ID included as part of the first data packet. Block 1110 may be implemented by a routing module, such as the routing modules 515 described above with reference to FIGS. 5-7.

At block 1115, the first data packet is forwarded based at least in part on the geographic destination and a current wireless capacity of the vehicle network. The data packet may be broadcasted and received by all vehicles within a transmission range of the first vehicle. In some examples, the method 1100 includes determining whether to wirelessly transmit the data packet from the first vehicle to a target vehicle. The determination may be based at least in part on a wireless capacity of the vehicle network (including the wireless capacity of one or more neighboring vehicles), a mobility pattern associated with a neighboring vehicle, and a metric of the data packet. Block 1115 may be implemented by a routing module, such as the routing modules 515 described above with reference to FIGS. 5-7. A determination to forward the data packet may be provided to a component of an apparatus, vehicle, etc. in order to execute the forwarding by either wirelessly transmitting the data packet or by instructing the apparatus, vehicle, etc. to continue carrying the data packet.

In another example, the method 1100 also includes determining the current wireless capacity of the vehicular network within a transmission range of the first vehicle. In some examples, determining the current wireless capacity of the vehicular network includes determining the wireless capacity of the current vehicle and/or determining the wireless capacity of one or more surrounding vehicles. For example, the method 1100 may include determining a current wireless capacity of a second vehicle in the vehicular network, wherein the second vehicle is located within the transmission range of the first vehicle.

In another example, the method 1100 includes determining a mobility pattern of at least a second vehicle located within a transmission range of the first vehicle, wherein forwarding the first data packet is further based at least in part on the determined mobility pattern. The mobility pattern for the second vehicle may include at least one of a direction of travel, a speed of travel, a route schedule, a destination of the second vehicle, or combinations thereof.

The method 1100 may also include determining a first mobility pattern of a second vehicle located within a transmission range of the first vehicle and determining a second mobility pattern of a third vehicle located within the transmission range of the first vehicle. The method 1100 may include comparing the first mobility pattern to the second mobility pattern and selecting a vehicle from the second vehicle and the third vehicle based at least in part on the comparison of the first mobility pattern and the second mobility pattern. The method 1100 may include forwarding the first data packet to the selected vehicle. In some examples of the method 1100, selecting the vehicle based at least in part on the second mobility pattern indicating that the second vehicle is expected to be closer to the geographic destination than the third vehicle and a wireless capacity of the second vehicle indicating that the second vehicle has available wireless capacity for the first data packet. In other examples, the method 1100 does not include selecting a vehicle because the data packet is broadcast to every vehicle within transmission range of the current vehicle. However, in some examples, a determination whether to forward a data packet may be based on whether a surrounding vehicle is a preferred target vehicle.

In further examples of the method 1100, a plurality of data packets is received at the first vehicle, including the first data packet. In such an example, the method 1100 may further include determining a metric value for each of the plurality of data packets. The method 1100 may also include selecting the first data packet from the plurality of data packets based at least in part on the first data packet having a highest metric value among the one or more data packets.

In yet further examples of the method 1100, the metric value is based at least in part on one or more of whether a geographic destination of the first data packet is within a transmission range of the first vehicle, an expiration timer of the first data packet, whether the geographic destination is within a transmission range of a second vehicle located within transmission range of the first vehicle, whether the geographic destination is within a transmission range of a third vehicle located within a transmission range of the second vehicle, and combinations thereof. In some examples, the metric value is based at least in part on a type of the first vehicle. Further, the metric value is based at least in part on a ratio of a distance between a current location of the first vehicle and the geographic destination and a distance between a location of a source of the first data packet and the geographic destination.

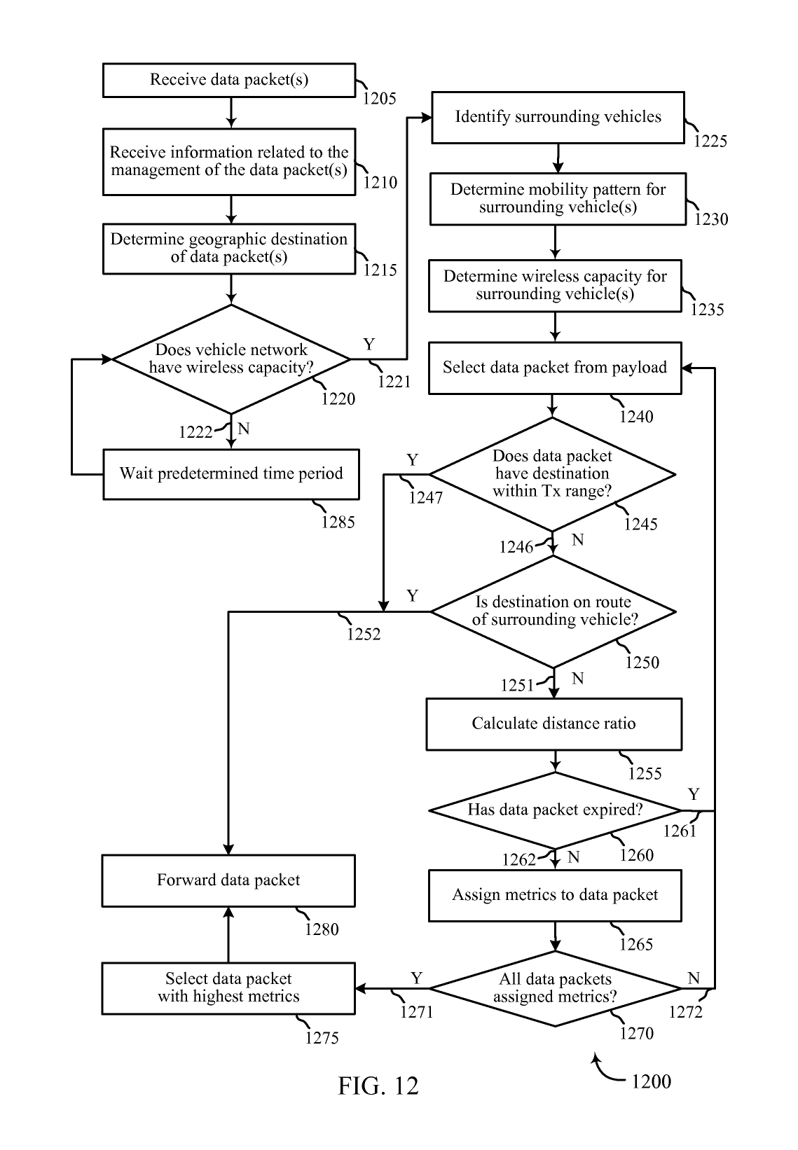

FIG. 12 shows a flowchart of another example of a method 1200 for wireless communication in accordance with various embodiments. The functions of the method 1200 may be implemented by an apparatus 505 as described above with reference to FIGS. 5-7 and/or 9 and/or a vehicle 120 as described above with reference to FIGS. 1-3 and/or 9, or any combination of these or any one of their components.

At block 1205, the vehicle 120 may receive one or more data packets. The one or more data packets may be received from another vehicle, or from a stationary node, such as a base station or home or office. The one or more data packets may include data that is to be transferred to a location away from the source. At block 1210, the vehicle receives information related to the management of the one or more data packets. For example, the vehicle could receive mobility and/or geographic destination information from other vehicles and/or from a communications infrastructure external to the vehicle 120. In some embodiments, the vehicle 120 could receive a direction or instruction to wirelessly transmit a data packet to a target, such as another vehicle. In other embodiments, the vehicle 120 receives the information and makes a determination itself whether or not a data packet should or should not be transmitted.

At block 1215, a determination of the geographic destinations of the one or more data packets is made. The vehicle network capacity is checked at block 1220. If the vehicle network does not have wireless capacity to forward any data packets at that time, along path 1222, the method 1200 waits a predetermined time period at block 1285 until the method 1200 again assesses whether the vehicle network has wireless capacity at block 1220.

Once it is determined that the vehicle network does have wireless capacity to forward a data packet, the method 1200 proceeds along path 1221 to identify one or more surrounding vehicles at block 1225. The method 1200 may also include determining the mobility patterns for the one or more surrounding vehicles at block 1230. In some examples, the method 1200 does not identify the surrounding vehicles or determine their mobility pattern.

At block 1235, the method 1200 determines the wireless capacity for each of the surrounding vehicles. In other examples, the method 1200 does not check the wireless capacity for each of the surrounding vehicles since the wireless capacity of the vehicle network may have already been checked at block 1220.

At block 1240, a data packet is selected from payload of the plurality of data packets. For each data packet, the blocks 1245, 1250, 1255, 1260, 1265 may be performed before any data packet is selected for forwarding. However, the method 1200 illustrates an example where some data packets are forwarded once a specific condition exists.

The method 1200 determines whether the data packet has a destination within transmission range of the current vehicle at block 1245. If so, and the vehicle network has wireless capacity, the current vehicle forwards the data packet to the destination at block 1280, following path 1247. If the data packet does not have a destination within transmission range of the current vehicle, the method 1200 proceeds along path 1246 to determine whether the destination is on the route of a surrounding vehicle at block 1250. If so, and the vehicle network has wireless capacity, the current vehicle forwards the data packet to the surrounding vehicle at block 1280, following path 1252. If the data packet does not have a destination on the route of a surrounding vehicle, the method 1200 proceeds along path 1251 to block 1255.

At block 1255, the method 1200 calculates a distance ratio as described above. At block 1260, the method 1200 determines whether the data packet has expired. If so, the method 1200 proceeds along path 1261 to select another data packet for analysis at block 1240. If not, the method 1200 proceeds along path 1262 to block 1265. At block 1265, a metric value is assigned to the data packet, based on the distance ratio, a weight factor of the destination of the data packet (assuming it had not already been forwarded), and a time to expiration of the data packet.

At block 1270, the method 1200 checks whether there are any more data packets to be assigned metrics. If so, the method 1200 proceeds along path 1272 and selects another data packet from the payload at block 1240. The method 1200 then proceeds to follow the blocks 1245, 1250, 1255, 1260, 1265 for the new data packet. If all the data packets have been assigned a metric value, the method 1200 proceeds along path 1271 to select a data packet with the highest metrics at block 1275. The method 1200 then forwards the selected data packet at block 1280.

The examples described herein may attempt to utilize the transportation capability brought by vehicle mobility as much as possible. In some examples, a data packet may only be forwarded using wireless capacity if it is deemed to be getting off-track to its current destination. In some examples, when a data packet gets to its destination or is within the vicinity of another vehicle which is known to be heading to the destination, that data packet may be given high priority to be transmitted. However, it should be noted, that when the wireless capability is underutilized, even packets on the right route may begin to be forwarded. This may help to cut down an end-to-end delay of packet transmissions in such vehicle networks. The examples described herein that include determinations of wireless capacity as well as mobility patterns may reduce the transmission time for a packet that otherwise, relying only on mobility comparable to the driving and/or travel time between two locations, would take much longer than the multi-hop forwarding time. The techniques and systems described herein may automatically take care of this through the metric determination described herein.

It should be noted that the methods 1100 and 1200 are just example embodiments of the operations described with relation to the methods 1100 and 1200, and that the steps may be rearranged or otherwise modified such that other embodiments are possible.

The detailed description set forth above in connection with the appended drawings describes exemplary embodiments and does not represent the only embodiments that may be implemented or that are within the scope of the claims. The term “exemplary” used throughout this description means “serving as an example, instance, or illustration,” and not “preferred” or “advantageous over other embodiments.” The detailed description includes specific details for the purpose of providing an understanding of the described techniques. These techniques, however, may be practiced without these specific details. In some instances, well-known structures and devices are shown in block diagram form in order to avoid obscuring the concepts of the described embodiments.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and embodiments are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the scope of the disclosure. Throughout this disclosure the term “example” or “exemplary” indicates an example or instance and does not imply or require any preference for the noted example. Thus, the disclosure is not to be limited to the examples and designs described herein but is to be accorded the widest scope consistent with the principles and novel features disclosed herein.

What is claimed is:

1. A method of wireless communication, comprising:
receiving a first data packet at a first vehicle in a vehicular network;
determining a geographic destination of the received first data packet; and
forwarding the first data packet based at least in part on the geographic destination and a current wireless capacity of the vehicular network.

2. The method of claim 1, further comprising:
determining the current wireless capacity of the vehicular network within a transmission range of the first vehicle.

3. The method of claim 2, wherein determining the current wireless capacity of the vehicular network within the transmission range of the first vehicle further comprises:
determining a current wireless capacity of a second vehicle in the vehicular network, wherein the second vehicle is located within the transmission range of the first vehicle.

4. The method of claim 1, further comprising:
determining a mobility pattern of at least a second vehicle located within a transmission range of the first vehicle, wherein forwarding the first data packet is further based at least in part on the determined mobility pattern.

5. The method of claim 4, wherein the mobility pattern for the second vehicle comprises at least one of a direction of travel, a speed of travel, a route schedule, a destination of the second vehicle, or combinations thereof.

6. The method of claim 1, further comprising:
determining a first mobility pattern of a second vehicle located within a transmission range of the first vehicle;
determining a second mobility pattern of a third vehicle located within the transmission range of the first vehicle;
comparing the first mobility pattern to the second mobility pattern;
selecting a vehicle from the second vehicle and the third vehicle based at least in part on the comparison of the first mobility pattern and the second mobility pattern; and
forwarding the first data packet to the selected vehicle.

7. The method of claim 6, wherein selecting the vehicle further comprises:
selecting the vehicle based at least in part on the second mobility pattern indicating that the second vehicle is expected to be closer to the geographic destination than the third vehicle and a wireless capacity of the second vehicle indicating that the second vehicle has available wireless capacity for the first data packet.

8. The method of claim 1, further comprising:
wherein receiving the first data packet further includes receiving a plurality of data packets;
determining a metric value for each of the plurality of data packets; and
selecting the first data packet from the plurality of data packets based at least in part on the first data packet having a highest metric value among the plurality of data packets.

9. The method of claim 8, wherein the metric value is based at least in part on one or more of whether a geographic destination of the first data packet is within a first transmission range of the first vehicle, an expiration timer of the first data packet, whether the geographic destination is within a second transmission range of a second vehicle located within the first transmission range of the first vehicle, whether the geographic destination is within a third transmission range of a third vehicle located within the second transmission range of the second vehicle, and combinations thereof.

10. The method of claim 8, wherein the metric value is based at least in part on a type of the first vehicle.

11. The method of claim 8, wherein the metric value is based at least in part on a ratio of a first distance between a current location of the first vehicle and the geographic destination and a second distance between a location of a source of the first data packet and the geographic destination.

12. An apparatus for transferring data, comprising:
means for receiving a first data packet at a first vehicle in a vehicular network;
means for determining a geographic destination of the received first data packet; and
means for determining whether to wirelessly transmit the first data packet from a source to a target vehicle based at least in part on a physical mobility associated with the target vehicle.

13. The apparatus of claim 12, further comprising:
means for determining the current wireless capacity of the vehicular network within a transmission range of the first vehicle.

14. The apparatus of claim 13, wherein means for determining the current wireless capacity of the vehicular network within the transmission range of the first vehicle further comprises:
means for determining a current wireless capacity of a second vehicle in the vehicular network, wherein the second vehicle is located within the transmission range of the first vehicle.

15. The apparatus of claim 12, further comprising:
means for determining a mobility pattern of at least a second vehicle located within a transmission range of the first vehicle, wherein forwarding the first data packet is further based at least in part on the determined mobility pattern.

16. The apparatus of claim 15, wherein the mobility pattern for the second vehicle comprises at least one of a direction of travel, a speed of travel, a route schedule, a destination of the second vehicle, or combinations thereof.

17. The apparatus of claim 12, further comprising:
means for determining a first mobility pattern of a second vehicle located within a transmission range of the first vehicle;
means for determining a second mobility pattern of a third vehicle located within the transmission range of the first vehicle;
means for comparing the first mobility pattern to the second mobility pattern;
means for selecting a vehicle from the second vehicle and the third vehicle based at least in part on the comparison of the first mobility pattern and the second mobility pattern; and
means for forwarding the first data packet to the selected vehicle.

18. The apparatus of claim 17, wherein the means for selecting the vehicle further comprises:
means for selecting the vehicle based at least in part on the second mobility pattern indicating that the second vehicle is expected to be closer to the geographic destination than the third vehicle and a wireless capacity of the second vehicle indicating that the second vehicle has available wireless capacity for the first data packet.

19. The apparatus of claim 12, wherein the means for receiving the first data packet further includes means for receiving a plurality of data packets, the apparatus further comprising:
means for determining a metric value for each of the plurality of data packets; and
means for selecting the first data packet from the plurality of data packets based at least in part on the first data packet having a highest metric value among the plurality of data packets.

20. The apparatus of claim 19, wherein the metric value is based at least in part on one or more of whether a geographic destination of the first data packet is within a first transmission range of the first vehicle, an expiration timer of the first data packet, whether the geographic destination is within a second transmission range of a second vehicle located within the first transmission range of the first vehicle, whether the geographic destination is within a third transmission range of a third vehicle located within the second transmission range of the second vehicle, and combinations thereof.

21. The apparatus of claim 19, wherein the metric value is based at least in part on a type of the first vehicle.

22. The apparatus of claim 19, wherein the metric value is based at least in part on a ratio of a first distance between a current location of the first vehicle and the geographic destination and a second distance between a location of the source of the first data packet and the geographic destination.

23. An apparatus for transferring data, comprising:
a processor;
a memory in electronic communication with the processor; and
instructions stored in the memory, the instructions being executable by the processor to:
receive a first data packet at a first vehicle in a vehicular network;
determine a geographic destination of the received first data packet; and
forward the first data packet based at least in part on the geographic destination and a current wireless capacity of the vehicular network.

24. The apparatus of claim 23, the instructions being further executable by the processor to:
determine a current wireless capacity of a second vehicle in the vehicular network, wherein the second vehicle is located within a transmission range of the first vehicle.

25. The apparatus of claim 23, the instructions being further executable by the processor to:
determine a mobility pattern of at least a second vehicle located within a transmission range of the first vehicle, wherein forwarding the first data packet is further based at least in part on the determined mobility pattern.

26. The apparatus of claim 23, wherein receive the first data packet further includes receive a plurality of data packets, the instructions being further executable by the processor to:
determine a metric value for each of the plurality of data packets; and
select the first data packet from the plurality of data packets based at least in part on the first data packet having a highest metric value among the plurality of data packets.

27. A non-transitory computer-readable storage medium storing instructions executable by a processor to:
receive a first data packet at a first vehicle in a vehicular network;
determine a geographic destination of the received first data packet; and
forward the first data packet based at least in part on the geographic destination and a current wireless capacity of the vehicular network.

28. The non-transitory computer-readable storage medium of claim 27, the instructions being further executable by the processor to:
determine a current wireless capacity of a second vehicle in the vehicular network, wherein the second vehicle is located within a transmission range of the first vehicle.

29. The non-transitory computer-readable storage medium of claim 27, the instructions being further executable by the processor to:
determine a mobility pattern of at least a second vehicle located within a transmission range of the first vehicle, wherein forwarding the first data packet is further based at least in part on the determined mobility pattern.

30. The non-transitory computer-readable storage medium of claim 27, wherein receive the first data packet further includes receive a plurality of data packets, the instructions being further executable by the processor to:
determine a metric value for each of the plurality of data packets; and
select the first data packet from the plurality of data packets based at least in part on the first data packet having a highest metric value among the plurality of data packets.
